(19) United States
(12) Patent Application Publication
(10) Pub. No.: US 2011/0266025 A1
(43) Pub. Date: Nov. 3, 2011

(54) FLAME-RETARDANT RESIN COMPOSITION, AND INSULATED WIRE

(75) Inventor: Tsuyoshi Nonaka, Yokkaichi-shi (JP)

(73) Assignees: AUTONETWORKS TECHNOLOGIES, LTD., Yokkaichi-shi, Mie (JP); SUMITOMO ELECTRIC INDUSTRIES, LTD., Osaka-shi, Osaka (JP); SUMITOMO WIRING SYSTEMS, LTD., Yokkaichi-shi, Mie (JP)

(21) Appl. No.: 13/143,450

(22) PCT Filed: Jan. 20, 2010
(86) PCT No.: PCT/JP2010/050606

§ 371 Date: Jul. 6, 2011

(30) Foreign Application Priority Data
Feb. 2, 2009 (JP) 2009-021763

(51) Int. Cl. H01B 7/29; C08K 3/22

(52) U.S. Cl. 174/110 SR; 524/436; 523/457

(57) ABSTRACT

A flame-retardant resin composition that has an excellent cold-resistance property and wear-resistance property even when containing as a flame retardant a metallic hydrate such as magnesium hydroxide, and an insulated wire including the composition. The resin composition contains a flame retardant mainly consisting of a metallic hydrate, and a base resin, wherein the base resin contains two or more kinds of polyolefin resins having a flexural modulus of 2000 MPa or more, wherein at least one of the polyolefin resins has a melt flow rate (MFR) of 5 g/10 min or less. The base resin preferably further contains a polyolefin resin having a melt flow rate (MFR) of more than 5 g/10 min. At least one of the polyolefin resins is preferably a polypropylene resin having a functional group. The insulated wire includes a conductor, and an insulator containing the flame-retardant resin composition, with which the conductor is covered.

### TECHNICAL FIELD

The present invention relates to a flame-retardant resin composition, and an insulated wire including the same, and more specifically relates to a flame-retardant resin composition suitably used for automobile or electrical/electronic appliance, and an insulated wire including the same.

### BACKGROUND ART

Members and insulation members used for automobile or electrical/electronic appliance require a variety of properties such as a mechanical property, a flame retardant property, a heat-resistance property and a cold-resistance property. Conventionally, these members and insulation members are mainly made from polyvinyl chloride compounds, or compounds that contain a halogenous flame retardant containing chlorine atoms or bromine atoms in its molecules.

However, the materials from which these members and insulation members are made could give off enormous amounts of corrosive gas during incineration disposal. For this reason, using instead a non-halogenous flame-retardant material that has no possibility of giving off corrosive gas is proposed (see PTL1). In addition, for a non-halogenous flame-retardant resin composition, a composition is known which contains as a flame retardant a natural mineral mainly consisting of magnesium hydroxide (see PTL 2 to PTL 4).

### Citation List

### Patent Literature

PTL1: JP 2004-83612 A

PTL1: JP 3339154 B

PTL1: JP 3636675 B

PTL1: JP 2004-189905 A

### SUMMARY OF INVENTION

### Technical Problem

However, the conventionally-used non-halogenous flame-retardant resin composition that contains a polyolefin resin and the flame retardant that is the natural mineral mainly consisting of magnesium hydroxide has a problem of having an insufficient cold-resistance property and an insufficient wear-resistance property, which are required to be improved.

The present invention has been made in view of the problem described above, and an object of the present invention is to overcome the problem and to provide a flame-retardant resin composition that has an excellent cold-resistance property and an excellent wear-resistance property even when the composition contains as a flame retardant a metallic hydrate such as magnesium hydroxide, and an insulated wire including the composition.

### Solution to Problem

To achieve the objects and in accordance with the purpose of the present invention, a flame-retardant resin composition according to a preferred embodiment of the present invention contains a flame retardant mainly consisting of a metallic hydrate, and a base resin, wherein the base resin contains two or more kinds of polyolefin resins having a flexural modulus of 2000 MPa or more, wherein at least one of the two or more kinds of polyolefin resins has a melt flow rate (MFR) of 5 g/10 min or less.

In the flame-retardant resin composition, the base resin preferably further contains a polyolefin resin having a melt flow rate (MFR) of more than 5 g/10 min. A difference in melt flow rate between the polyolefin resin having the melt flow rate (MFR) of 5 g/10 min or less and the polyolefin resin having the melt flow rate (MFR) of more than 5 g/10 min is preferably 5 g/10 min or more. At least one of the two or more kinds of polyolefin resins is preferably a polypropylene resin having a functional group.

The functional group preferably includes one or more kinds of functional groups selected from a carboxylic acid group, an acid anhydrous group, an epoxy group, a hydroxyl group, an amino group, an alkenyl cyclic imino ether group, and a silane group. A content of the polypropylene resin having the functional group is preferably 10 to 30 parts by mass with respect to 100 parts by mass of the flame-retardant resin composition except the polypropylene resin having the functional group.

In another aspect of the present invention, an insulated wire includes a conductor, and an insulator containing the flame-retardant resin composition described above, with which the conductor is covered.

### Advantageous Effects of Invention

Containing the base resin that contains the two or more kinds of polyolefin resins having the flexural modulus of 2000 MPa or more, wherein at least one of the two or more kinds of polyolefin resins has the melt flow rate (MFR) of 5 g/10 min or less, the flame-retardant resin composition according to the preferred embodiment of the present invent ion has an excellent cold-resistance property and an excellent wear-resistance property even though the composition contains the flame retardant mainly consisting of the metallic hydrate.

When the base resin further contains the polyolefin resin having the melt flow rate (MFR) of more than 5 g/10 min, and the difference in melt flow rate between the polyolefin resin having the melt flow rate (MFR) of 5 g/10 minor less and the polyolefin resin having the melt flow rate (MFR) of more than 5 g/10 min is 5 g/10 min or more, the flame-retardant resin composition according to the preferred embodiment of the present invention has a more excellent wear-resistance property. The reason for this is assumed to lie in uneasy averaging of the hardness of the entire composition, which is brought by the polyolefin resins that are restrained from being dissolved in each other

In addition, when the at least one of the two or more kinds of polyolefin resins is the polypropylene resin having the functional group, the flame-retardant resin composition according to the preferred embodiment of the present invention, if used for covering a conductor, has an improved adhesion property to the conductor. Thus, the flame-retardant resin composition has an improved cold-resistance property and an improved wear-resistance property.

In addition, containing the flame-retardant resin composition according to the preferred embodiment of the present invention, the insulated wire according to the preferred embodiment of the present invention has an excellent cold-resistance property and an excellent wear-resistance property.

### DESCRIPTION OF EMBODIMENTS

A detailed description of preferred embodiments of the present invention will now be provided. A flame-retardant resin composition according to the preferred embodiment of the present invention (hereinafter, sometimes referred to as the present composition) contains a flame retardant and a base resin. The present composition may further contain another additive as necessary within a range of not impairing its physical properties such as a cold-resistance property and a wear-resistance property. Examples of the additive include an antioxidant, a filler and a coloring agent.

Examples of the base resin include a so-called non-halogenous plastic or rubber that contains no halogen element such as chlorine and bromine. The base resin preferably contains a polyolefin. resin. Specific examples of the polyolef in resin include a polyethylene resin, a polypropylene resin and EVA. A resin that has no functional group is preferably used for the base resin in view of cost reduction.

The polyolefin resin contained in the base resin is a combination of two or more different kinds of polyolefin resins. The two or more kinds of polyolefin resins all have a flexural modulus of 2000 MPa or more. At least one of the two or more kinds of polyolefin resins has a melt flow rate (MFR) of 5 g/10 min or less. Having the configuration described above, the present composition has an excellent cold-resistance property and an excellent wear-resistance property. The flexural modulus is measured in accordance with JIS K 7161. The melt flow rate (MFR) is measured in accordance with JIS K 6758 (at 230° C. under a load of 2.16 kg).

The flexural moduli of the two or more kinds of polyolefin resins are preferably 2100 MPa or more, and more preferably 2200 MPa or more, considering that the present composition can have an improved wear-resistance property. On the other hand, the upper limit of the flexural moduli is preferably 4000 MPa, and more preferably 3500 MPa, and still more preferably 3000 MPa, considering that the present composition can have an excellent low-temperature property (a property such that an insulated wire made from the composition is not cracked during a winding test performed at a low temperature).

The melt flow rate (MFR) of the polyolefin resin having the melt flow rate (MFR) of 5 g/10 min or less is preferably 3 g/10 min or less, and more preferably 1 g/10 min or less, considering that the present composition can have an improved wear-resistance property.

The lower limit of the melt flow rate (MFR) of the base resin is preferably 0.8 g/10 min, and more preferably 0.5 g/10 min, considering that if the melt flow rate is less than the lower limit, the fluidity and the moldability of the present composition could easily be lowered.

The base resin preferably contains a polyolefin resin having a melt flow rate (MFR) of more than 5 g/10 min in addition to the polyolefin resin having the melt flow rate (MFR) of 5 g/10 min or less. If a difference in melt flow rate between the polyolefin resin having the melt flow rate (MFR) of 5 g/10 min or less and the polyolefin resin having the melt flow rate (MFR) of more than 5 g/10 min is 5 g/10 min or more, the polyolefin resins are restrained from being dissolved in each other. Consequently, when the polyolefin resins have different flexural moduli, the hardness of the entire composition is not easily averaged, so that the properties of the polyolefin resin having a higher flexural modulus can be demonstrated with ease. Thus, the present composition can be expected to have an improved wear-resistance property.

The melt flow rate (MFR) of the polyolefin resin having the melt flow rate (MFR) of more than 5 g/10 min is preferably 10 g/10 min or more, and more preferably 15 g/10 min or more. These rates can widen the difference in melt flow. As the difference becomes wider, the properties of the polyolefin resin having a higher flexural modulus can be demonstrated more easily. Thus, the present composition can be expected to have an improved wear-resistance property.

The difference in melt flow rate between the polyolefin resin having the melt flow rate (MFR) of 5 g/10 min or less and the polyolefin resin having the melt flow rate (MFR) of more than 5 g/10 min is preferably 7 g/10 min or more, and more preferably 10 g/10 min or more.

The polyolefin resins contained in the base resin may have a functional group, or may have no functional group. It is preferable that at least one of the polyolefin resins has a functional group. A polypropylene resin is preferably used for the polyolefin resin having the functional group. The polypropylene resin having the functional group preferably has a melt flow rate (MFR) of more than 5 g/10 min.

Examples of the functional group include a carboxylic acid group (carboxyl group), an acid anhydrous group, an epoxy group, a hydroxyl group, an amino group, an alkenyl cyclic imino ether group, and a silane group. They may be used singly or in combination. The present composition containing the polyolefin resin having the functional group, if used for a covering member to cover a conductor for electric wire, can improve an adhesion property between the covering member and the conductor. This configuration can restrain the covering member from coming off the conductor even at low temperature, which improves the cold-resistance property. In addition, this configuration can restrain an interface between the covering member and the conductor from tearing even when a friction force (external force) is exerted on the covering member, which improves the wear-resistance property.

The functional group is introduced into the polyolefin resin by a method such that a compound having a functional group and a polyolefin resin are graft polymerized to obtain a graft modified olefin polymer, or by a method such that a compound having a functional group and an olefin monomer are copolymerized to obtain an olefin copolymer.

Specific examples of the compound having the carboxyl group or the acid anhydrous group as the functional group include an alpha, beta-unsaturated dicarboxylic acid such as a maleic acid, a fumaric acid, a citraconic acid and an itaconic acid, anhydrides thereof, and an unsaturated monocarboxylic acid such as an acrylic acid, a methacrylic acid, a fran acid, a crotonic acid, a vinylacetic acid and a pentane acid.

Specific examples of the compound having the epoxy group as the functional group include glycidyl acrylate, glycidyl methacrylate, an itaconic monoglycidyl ester, a butene tricarboxylic acid monoglycidyl ester, a butene tricarboxylic acid diglycidyl ester and a butene tricarboxylic acid triglycidyl ester, glycidyl esters such as an alpha-chloroacrylic acid, a maleic acid, a crotonic acid and a fumaric acid, glycidyl ethers such as a vinyl glycidyl ether, an allyl glycidyl ether, a glycidyl oxyethyl vinyl ether and a styrene-p-glycidyl ether, and p-glycidyl styrene.

Specific examples of the compound having the hydroxyl group as the functional group include 1-hydroxypropyl (meth)acrylate, 2-hydroxypropyl (meth)acrylate, and hydroxyethyl (meth)acrylate.

Specific examples of the compound having the amino group as the functional group include aminoethyl (meth)acrylate, propylaminoethyl (meth)acrylate, dimethylaminoethyl (meth) acrylate, diethylaminoethyl (meth)acrylate, dibutylaminoethyl (meth)acrylate, aminopropyl (meth) acrylate, phenylaminoethyl (meth) acrylate, and cyclohexylaminoethyl (meth) acrylate.

Specific examples of the compound having the alkenyl cyclic imino ether group as the functional group include 2-vinyl-2-oxazolin, 2-isopropenyl-2-oxaxolin, 2-vinyl-5,6-dihydro-4H-1,3-oxazine, and 2-isopropenyl-5,6-dihydro-4H-1,3-oxazine.

Specific examples of the compound having the silane group as the functional group include an unsaturated s lan compound such as vinyltrimethoxysilane, vinyltriethoxysilane, vinyltriacetylsilane, and vinyltrichlorosilane.

A content of the polyolefin resin having the functional group is preferably 10 to 30 parts by mass with respect to 100 parts by mass of the present composition except the polyolefin resin having the functional group. This is because if the content is less than 10 parts by mass, the composition, if used for an insulating layer of an insulated wire, could not have asufficientwear-resistanceproperty. Ontheotherhand, if the content is more than 30 parts by mass, the composition, if used for an insulating layer of an insulated wire, could have a cold-resistance property worsened. The content is more preferably 12 to 28 parts by mass, and still more preferably 15 to 25 parts by mass with respect to 100 parts by mass of the present composition except the polyolefin resin having the functional group.

A molecular weight (weight-average molecular weight) of the polyolefin resins contained in the base resin is within the range of 1000 to 1000000. This is because if the molecular weight is less than 1000, the effect of improving the wear-resistance property could be lessened. On the other hand, if the molecular weight is more than 1000000, the present composition could have moldability worsened.

The flame retardant mainly consists of a metallic hydrate. Examples of the metallic hydrate include magnesium hydroxide, aluminum hydroxide and calcium hydroxide. The magnesium hydroxide is preferably used. Natural magnesium hydroxide that is prepared by pulverizing a natural mineral, or synthesized magnesium hydroxide that is obtained by synthesis from seawater is preferably used for the magnesium hydroxide.

The average particle size of the flame retardant is 0.1 to 20 μm, preferably 0.2 to 10 μm, and more preferably 0.5 to 5 μm. This is because if the average particle size is less than 0.1 μm, secondary cohesion could easily occur to demonstrate a tendency to degrade a mechanical property of the present composition. On the other hand, if the average particle size is more than 20 μm, the present composition, when used for an insulating layer of an insulated wire, could cause the insulating layer to have marred surface appearance.

The flame retardant content is usually 30 to 250 parts by mass with respect to 100 parts by mass of the base resin, considering that a flame retardant property required for insulated wires for automobiles can be acquired. The flame retardant content is preferably 50 to 200 parts by mass, and more preferably 60 to 180 parts by mass with respect to 100 parts by mass of the base resin.

The flame retardant may be surface treated with a surface treatment agent. Examples of the surface treatment agent include alpha-olefin homopolymer or copolymer such as 1-heptene, 1-octene, 1-nonene and 1-decene, and a mixture of the homopolymer and the copolymer. The surface treatment agent may be modified.

Examples of the modification of the surface treatment agent include acid modification that a carboxyl group (acid) is introduced into a polymer such as the above-described alpha-olefin polymer using an unsaturated carboxylic acid or its derivative as a modifying agent. Specific examples of the modifying agent include a maleic acid and a fumaric acid as the unsaturated carboxylic acid, and a maleic acid anhydride (MAH), a maleic acid monoester and a maleic acid diester as the derivative. Among them, the maleic acid and the maleic acid anhydride are preferably used. They may be used singly or in combination. The acid is introduced into the surface treatment agent by a graft polymerization method or a direct polymerization method. The amount of the used acid, on a percentage by mass basis of the used modifying agent, is preferably 0.1 to 20% by mass, more preferably 0.2 to 10% by mass, and still more preferably 0.2 to 5% by mass with respect to the polymer.

A method for surface treating the flame retardant with the surface treatment agent is not limited specifically. Avariety of surface treatment methods can be used. Examples of the method for surface treating the flame retardant include a method for surface treating the flame retardant concurrently with pulverization of the flame retardant, and a method for surface treating the flame retardant after mixing the flame retardant that is in advance pulverized and the surface treatment agent. The surface treatment method is preferably a wet method using a solvent, or a dry method using no solvent.

In using the wet method, examples of the solvent include an aliphatic hydrocarbon such as pentane, hexane and heptane, and an aromatic hydrocarbon such as benzene, toluene and xylene. In addition, examples of the method for surface treating the flame retardant include a surface treatment method such that a surface treatment agent is added to a flame retardant and a resin at the time of preparing a flame-retardant resin composition, and then the flame retardant is surface treated at the time of kneading the composition.

A method for producing the flame-retardant resin composition is not limited specifically, and a variety of known methods can be used for the method. The flame-retardant resin composition can be prepared by melting, kneading and uniformly dispersing the ingredients with the use of an ordinary kneader such as a Banbury mixer, a pressure kneader, a kneading extruder, a twin screw extruder and a roll.

The flame-retardant resin composition can be used for members and insulation members used for automobile or electrical/electronic appliance, and can be more preferably used for an insulating layer of an insulated wire.

An insulated wire according to the preferred embodiment of the present invention is produced such that the flame-retardant resin composition is extruded by an extrusion molding machine, which is used for producing a general insulated wire, so as to cover a conductor, by which an insulating layer made from the flame-retardant resin composition is formed around the conductor. A conductor that is used for a general insulated wire is used for the conductor of the insulated wire according to the preferred embodiment of the present invention.

The diameter of the conductor, and the thickness of the insulating layer of the insulated wire, which are not limited specifically, may be determined depending on the intended use. The insulating layer may be a single layer, or a multilayer.

### EXAMPLE

A description of the present invention will now be specifically provided with reference to Examples and Comparative Examples; however, the present invention is not limited thereto.

### Example 1

A flame-retardant resin composition according to Example 1 that contained a base resin containing 30 parts by mass of polypropylene resin having no functional group (manuf.: JAPAN POLYPROPYLENE CORPORATION, trade name: “FL6H”, MFR=3.0 g/10 min, flexural modulus=2600 MPa) and 20 parts by mass of polypropylene resin having no functional group (manuf.: JAPAN POLYPROPYLENE CORPORATION, trade name: “MA3AHTA”, MFR=12 g/10 min, flexural modulus=2400 MPa), 49 parts by mass of magnesium hydroxide (manuf.: KYOWA CHEMICAL INDUSTRY CO., LTD., trade name : “KISUMA 5A”), and 1 part by mass of antioxidant (manuf.: CIBA SPECIALTY CHEMICALS INC., trade name: “Irganox 1010”) was prepared by kneading the ingredients at 200° C. using a twin-screw kneader, and the mixture was pelletized using a pelletizing machine. Then, an insulated wire according to Example 1 was prepared by extrusion-covering a conductor (cross sectional area: 0.5 mm²), which was a soft-copper strand prepared by bunching seven soft copper wires, with an insulating layer made from the pellets of the prepared flame-retardant resin composition to have a thickness of 0.2 mm using an extrusion molding machine.

### Examples 2 to 8, Comparative Examples 1 to 7

Flame-retardant resin compositions according to Examples 2 to 8 and Comparative Examples 1 to 7 were prepared in the same manner as the composition according to Example 1 except that the contained base resins contained the respective polypropylene resins shown in the section of Ingredient composition in Table I. Then, insulated wires according to Examples 2 to 8 and Comparative Examples 1 to 7 were prepared using the respective compositions in the same manner as Example 1.

The obtained insulated wires according to the present Examples and the Comparative Examples were subjected to a cold-resistance test and a wear-resistance test. The test results are shown in Table 1. A test procedure of the cold-resistance test and a test procedure of the wear-resistance test are described below.

[Test Procedure of Cold-Resistance Test]

The cold-resistance test was performed in accordance with JIS 03005. To be specific, the prepared insulated wires according to the present Examples and the Comparative Examples were cut into test specimens 38 mm long. Five test specimens for each insulated wire were set in a cold-resistance test machine and hit with a striking implement while being cooled to a given temperature, and the temperature at the time when all of the five test specimens broke was determined as a cold-resistance temperature of the insulated wire.

[Test Procedure of Wear-Resistance Test]

The wear-resistance test was performed by a blade-reciprocating method in accordance with NASO D611-94. To be specific, the insulated wires according to the present Examples and the Comparative Examples were cut into test specimens 750 mm long, and then a blade was made to reciprocate at a speed of 50 times/minute in a direction of its shaft over a length of 10 mm on the covering member (insulating layer) of each test specimen at a room temperature of 23±5° C., and the number of reciprocation before the blade touches the conductor due to the wearing out of the covering member was counted. A load imposed on the blade was set at 7 N. The test specimen whose reciprocation number was 400 or more was regarded as successfully passed. The test specimen whose reciprocation number was 200 to less than 400 was regarded as passed. The test specimen whose reciprocation number was less than 200 was regarded as failed.

TABLE 1

| | Example | | | | | | | | Comparative Example | | | | | | |
|---|---|---|---|---|---|---|---|---|---|---|---|---|---|---|---|
| | 1 | 2 | 3 | 4 | 5 | 6 | 7 | 8 | 1 | 2 | 3 | 4 | 5 | 6 | 7 |
| Ingredient | | | | | | | | | | | | | | | |
| Composition | | | | | | | | | | | | | | | |
| (parts by mass) | | | | | | | | | | | | | | | |
| Olefin resin (FL6H) | 30 | — | — | 30 | 30 | — | — | — | — | — | — | — | — | — | — |
| Olefin resin (FY6C) | — | 30 | — | — | — | 30 | — | — | — | — | — | — | — | — | — |
| Olefin resin (EA9BT) | — | — | 30 | — | — | — | 30 | — | — | — | — | — | — | — | — |
| Olefin resin (EC7) | — | — | — | — | — | — | — | — | 30 | — | — | — | — | — | — |
| Olefin resin (MA3H) | — | — | — | — | — | — | — | — | — | 30 | — | — | — | 30 | — |
| Olefin resin (CL0785) | — | — | — | — | — | — | — | — | — | — | 30 | — | — | — | 30 |
| Olefin resin (J106MG) | — | — | — | — | 20 | — | 20 | — | — | — | — | 30 | — | — | 20 |
| Olefin resin (J108M) | — | — | — | 20 | — | 20 | — | — | — | — | — | — | 30 | 20 | — |
| Olefin resin | 20 | 20 | 20 | — | — | — | — | — | 20 | 20 | 20 | 20 | 20 | — | — |
| (MA3AHTA) | | | | | | | | | | | | | | | |
| Olefin resin <1> | — | — | — | — | — | — | — | 30 | — | — | — | — | — | — | — |
| Olefin resin (AT2377) | — | — | — | — | — | — | — | 20 | — | — | — | — | — | — | — |
| Magnesiuim | 49 | 49 | 49 | 49 | 49 | 49 | 49 | 49 | 49 | 49 | 49 | 49 | 49 | 49 | 49 |
| hydroxide | | | | | | | | | | | | | | | |
| Antioxidant | 1 | 1 | 1 | 1 | 1 | 1 | 1 | 1 | 1 | 1 | 1 | 1 | 1 | 1 | 1 |
| Test result | | | | | | | | | | | | | | | |
| Cold-resistance | −20 | −25 | −25 | −30 | −25 | −20 | −20 | −20 | −20 | −15 | −10 | −10 | −10 | −15 | −10 |
| property | | | | | | | | | | | | | | | |
| Wear-resistance | Passed | Passed | Passed | Passed | Passed | Passed | Passed | Success- | Failed | Failed | Failed | Failed | Failed | Failed | Failed |
| property | | | | | | | | fully | | | | | | | |
| | | | | | | | | Passed | | | | | | | |

FL6H: manuf.: JAPAN POLYPROPYLENE CORPORATION, a polypropylene resin having no functional group, MFR = 3.0 g/10 min, flexural modulus = 2600 MPa
FY6C: manuf.: JAPAN POLYPROPYLENE CORPORATION, a polypropylene resin having no functional group, MFR = 2.4 g/10 min, flexural modulus = 2100 MPa
EA9BT: manuf.: JAPAN POLYPROPYLENE CORPORATION, a polypropylene resin having no functional group, MFR = 0.5 g/10 min, flexural modulus = 2200 MPa
EC7: manuf.: JAPAN POLYPROPYLENE CORPORATION, a polypropylene resin having no functional group, MFR = 0.5 g/10 min, flexural modulus = 1200 MPa
MA3H: manuf.: JAPAN POLYPROPYLENE CORPORATION, a polypropylene resin having no functional group, MFR = 10 g/10 min, flexural modulus = 2000 MPa
CL0785: manuf.: JAPAN POLYPROPYLENE CORPORATION, a polypropylene resin having no functional group, MFR = 30 g/10 min, flexural modulus = 2800 MPa
J106MG: manuf.: PRIME POLYMER CO., LTD, a. polypropylene resin having no functional group, MFR = 15 g/10 min, flexural modulus = 2050 MPa
J108MG: manuf.: PRIME POLYMER CO., LTD, a polypropylene resin having no functional group, MFR = 45 g/10 min, flexural modulus = 2000 MPa
MA3AHTA: manuf.: JAPAN POLYPROPYLENE CORPORATION, a polypropylene resin having no functional group, MFR = 12 g/10 min, flexural modulus = 2400 MPa
Polyolefin resin <1>: a synthetic resin, a polypropylene resin having no functional group, MFR = 4.5 g/10 min, flexural modulus = 2200 MPa
AT2377 : manuf.: MITSUI CHEMICALS, INC., a polypropylene resin having an acid anhydrous group, MFR = 20 g/10 min, flexural modulus = 2200 MPa
Magnesium hydroxide: manuf.: KYOWA CHEMICAL INDUSTRY CO., LTD., trade name: “KISUMA 5A”
Antioxidant: manuf.: CIBA SPECIALTY CHEMICALS INC., trade name: “Irganox 1010”

As shown in Table 1, the insulated wires according to Examples 1 to 8 had cold-resistance temperatures of −20° C. to −30° C., that is, they had favorable cold-resistance properties, and had wear-resistance properties that have passed. It was found that the insulated wire had the more excellent wear-resistance property especially when the polyolefin resin having the functional group was contained in the composition. In contrast, the insulated wire according to Comparative Example 1 had a wear-resistance property that has failed because one of the polyolefin. resins contained in the base resin had the flexural modulus of less than 2000 MPa. In addition, the insulated wires according to Comparative Examples 2 to 7 had cold-resistance properties that were inferior to the insulated wires according to the present Examples, and wear-resistance properties that have failed because none of the polyolefin resins contained in the base resin had MFR of 5 g/10 min or less.

The foregoing description of the preferred embodiments of the present invention has been presented for purposes of illustration and description; however, it is not intended to be exhaustive or to limit the present invention to the precise form disclosed, and modifications and variations are possible as long as they do not deviate from the principles of the present invention.

1-7. (canceled)

8. A flame-retardant resin composition containing:
a flame retardant mainly consisting of a metallic hydrate; and
a base resin,
wherein the base resin contains two or more kinds of polyolefin resins having a flexural modulus of 2000 MPa or more, wherein at least one of the two or more kinds of polyolefin resins has a melt flow rate (MFR) of 5 g/10 min or less.

9. The flame-retardant resin composition according to claim 8, wherein the base resin further contains a polyolefin resin having a melt flow rate (MFR) of more than 5 g/10 min.

10. The flame-retardant resin composition according to claim 9, wherein a difference in melt flow rate between the polyolefin resin having the melt flow rate (MFR) of 5 g/10 min or less, and the polyolefin resin having the melt flow rate (MFR) of more than 5 g/10 min is 5 g/10 min or more.

11. The flame-retardant resin composition according to claim 10, wherein at least one of the two or more kinds of polyolefin resins comprises a polypropylene resin having a functional group.

12. The flame-retardant resin composition according to claim 11, wherein the functional group comprises one or more kinds of functional groups selected from a carboxylic acid group, an acid anhydrous group, an epoxy group, a hydroxyl group, an amino group, an alkenyl cyclic imino ether group, and a silane group.

13. The flame-retardant resin composition according to claim 12, wherein a content of the polypropylene resin having the functional group is 10 to 30 parts by mass with respect to 100 parts by mass of the flame-retardant resin composition except the polypropylene resin having the functional group.

14. The flame-retardant resin composition according to claim 11, wherein a content of the polypropylene resin having the functional group is 10 to 30 parts by mass with respect to 100 parts by mass of the flame-retardant resin composition except the polypropylene resin having the functional group.

15. An insulated wire comprising;
a conductor; and
an insulator containing the flame-retardant resin composition according to claim 10, with which the conductor is covered.

16. The flame-retardant resin composition according to claim 9, wherein at least one of the two or more kinds of polyolefin resins comprises a polypropylene resin having a functional group.

17. The flame-retardant resin composition according to claim 16, wherein the functional group comprises one or more kinds of functional groups selected from a carboxylic acid group, an acid anhydrous group, an epoxy group, a hydroxyl group, an amino group, an alkenyl cyclic imino ether group, and a silane group.

18. The flame-retardant resin composition according to claim 16, wherein a content of the polypropylene resin having the functional group is 10 to 30 parts by mass with respect to 100 parts by mass of the flame-retardant resin composition except the polypropylene resin having the functional group.

19. An insulated wire comprising;
a conductor; and
an insulator containing the flame-retardant resin composition according to claim 9, with which the conductor is covered.

20. The flame-retardant resin composition according to claim 8, wherein at least one of the two or more kinds of polyolefin resins comprises a polypropylene resin having a functional group.

21. The flame-retardant resin composition according to claim 20, wherein the functional group comprises one or more kinds of functional groups selected from a carboxylic acid group, an acid anhydrous group, an epoxy group, a hydroxyl group, an amino group, an alkenyl cyclic imino ether group, and a silane group.

22. The flame-retardant resin composition according to claim 21, wherein a content of the polypropylene resin having the functional group is 10 to 30 parts by mass with respect to 100 parts by mass of the flame-retardant resin composition except the polypropylene resin having the functional group.

23. An insulated wire comprising;
a conductor; and
an insulator containing the flame-retardant resin composition according to claim 21, with which the conductor is covered.

24. The flame-retardant resin composition according to claim 20, wherein a content of the polypropylene resin having the functional group is 10 to 30 parts by mass with respect to 100 parts by mass of the flame-retardant resin composition except the polypropylene resin having the functional group.

25. An insulated wire comprising;
a conductor; and
an insulator containing the flame-retardant resin composition according to claim 24, with which the conductor is covered.

26. An insulated wire comprising;
a conductor; and
an insulator containing the flame-retardant resin composition according to claim 20, with which the conductor is covered.

27. An insulated wire comprising;
a conductor; and
an insulator containing the flame-retardant resin composition according to claim 8, with which the conductor is covered.
